(19) United States
(12) Patent Application Publication
(10) Pub. No.: US 2019/0005094 A1
(43) Pub. Date: Jan. 3, 2019

(54) METHOD FOR APPROXIMATE PROCESSING OF COMPLEX JOIN QUERIES

(71) Applicants: UNIVERSITY OF UTAH RESEARCH FOUNDATION, Salt Lake City, UT (US); HONG KONG UNIVERSITY OF SCIENCE AND TECHNOLOGY, Kowloon (HK)

(72) Inventors: Ke Yi, Kowloon (HK); Feifei Li, Salt Lake City, UT (US)

(21) Appl. No.: 16/063,998

(22) PCT Filed: Dec. 20, 2016
(86) PCT No.: PCT/US16/67887

§ 371 Date: Jun. 19, 2018

Related U.S. Application Data
(60) Provisional application No. 62/387,049, filed on Dec. 21, 2015.

(51) Int. Cl. G06F 17/30

(52) U.S. Cl. CPC G06F 17/30466; G06F 17/30554; G06F 17/30339; G06F 17/30498

(57) ABSTRACT

Systems are provided for processing of complex join queries. The systems receive a join query directed towards a set of tables. The systems randomly select an attribute from an index associated with a table from the set of tables. The selected attribute is selected based upon a query applied to the table. The systems identify a number of possible pathways from the selected attribute to a set of attributes in another table within the set of tables. Each pathway is representative of a possible join between the selected attribute and the attributes within the set of attributes. The systems then identify a terminating attribute within the set of tables. A contribution of the terminating attribute to a result is weighted by a number of possible pathways identified between an initial set of attributes and the terminating attribute.

### CROSS-REFERENCE TO RELATED APPLICATIONS

This application claims the benefit of and priority to U.S. Provisional Patent Application Ser. No. 62/387,049 filed on Dec. 21, 2015, entitled “Method for Approximate Processing of Complex Join Queries,” which application is expressly incorporated herein by reference in its entirety.

BACKGROUND

### Background and Relevant Art

Computers and computing systems have affected nearly every aspect of modern living. Computers are generally involved in work, +recreation, healthcare, transportation, entertainment, household management, etc. One common use of computers is with the database and data processing field. For example, the advent of big data processing has encouraged tremendous growth with the database management and storage field. Modern day database systems provide a wide-array of complex and useful operations that can be performed on a dataset.

Joins are often considered as one of the most central operations in relational databases, as well as one of the costliest ones. For many of today's data-driven analytical tasks, users often need to pose ad hoc complex join queries involving multiple relational tables over gigabytes or even terabytes of data. The TPC-H benchmark, which is the industrial standard for decision-support data analytics, specifies 22 queries, 17 of which are joins, the most complex one involving 8 tables. For such complex join queries, even a leading commercial database system could take hours to process. This, unfortunately, is at odds with the low-latency requirement that users demand for interactive data analytics.

The research community has long realized the need for interactive data analysis and exploration, and in 1997, initialized a line of work known as “online aggregation”. The observation is that such analytical queries do not need a 100% accurate answer. It would be more desirable if the database could first quickly return an approximate answer with some form of quality guarantee (usually in the form of confidence intervals), while improving the accuracy as more time is spent. Then the user can stop the query processing as soon as the quality is acceptable. This will significantly improve the responsiveness of the system, and at the same time saves a lot of computing resources.

Unfortunately, online aggregation has had limited practical impact; no commercial or full-fledged open source database systems have adopted this technique. One conventional system that has unsuccessfully attempted to fill this gap is the ripple join algorithm. A ripple join system repeatedly takes windows of samples from each table within the join command, and only performs the join on the windows of sampled tuples. The result is then scaled up to serve as an estimation of the whole join. However, the ripple join algorithm (including its many variants) has two critical weaknesses that have prevented it from being widely adopted. First, its performance crucially depends on the fraction of the randomly selected tuples that could actually join. However, this fraction is often exceedingly low, especially for equality joins (a.k.a. natural joins) involving multiple tables, while all queries in the TPC-H benchmark (thus arguably most joins used in practice) are natural joins. Second, it requires that the tuples in each table be stored in a random order. Unfortunately, conventional database systems do not store tuples in this way, for many technical reasons.

Accordingly, there is a need in the art for systems, methods, and apparatus that are capable of quickly performing join operations and providing confidence levels relating to the requested data. Further, there is a need to provide systems, methods, and apparatus that are capable of operating within conventional, ordered databases. Embodiments disclosed herein provide significant improvements to the art and solutions to one or more of these needs.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein include systems for processing of complex join queries. In at least one embodiment, the systems receive a join query directed towards a set of tables. The systems randomly select an attribute from an index associated with a table from the set of tables. The selected attribute is selected based upon a query applied to the table. The systems identify a number of possible pathways from the selected attribute to a set of attributes in another table within the set of tables. Each pathway is representative of a possible join between the selected attribute and the attributes within the set of attributes. The systems then identify a terminating attribute within the set of tables. A contribution of the terminating attribute to a result is weighted by a number of possible pathways identified between an initial set of attributes and the terminating attribute.

Disclosed embodiments also include at least one other system for processing of complex join queries. For example, the system receives a join query directed towards generating a particular result based at least in part on data contained within a first table and a second table. In response to the query, the system accesses a first index associated with a first column of the first table. The system identifies from the first index a set of first attributes that conform with the join query. The system randomly selects a particular first attribute from the set of first attributes. The system then accesses a second index associated with a second column of the second table. The system identifies, from the second index, a set of second attributes to which the particular first attribute maps. The system randomly selects a particular second attribute from the set of second attributes. The system then calculates the particular result to the join query based, at least in part, upon the particular second attribute. A contribution of the particular second attribute to the particular result is weighted by a probability factor determined at least in part by a number of first attributes in the first set of attributes and a number of second attributes in the second set of attributes.

Additionally, disclosed embodiments include a method for approximate processing of complex join queries. The method comprises receiving a join query directed towards a set of tables. Each table within the set of tables is associated with an index for at least one column of attributes within the table. The method also comprises performing a threshold number of join operations on the set of tables for various different orderings of tables within the set of tables. For each specific ordering of tables, the method comprises tracking a number of successful walks, wherein a successful walk is completed when a pathway is identified between a first table and a last table. The method then comprises identifying from within the various different orderings an ideal ordering that resulted in a highest proportion of successful walks.

Additionally, the method includes randomly selecting an attribute from an index associated with a first table from the set of tables. The selected attribute is associated with the join query. The method then includes identifying a number of possible pathways from the selected attribute to a set of attributes in a second table within the set of tables. Each pathway is representative of a possible join between the selected attribute and the attributes within the set of attributes. The second table is also ordered after the first table within the ideal ordering. The method further comprises identifying a terminating attribute within the second table. The terminating attribute is responsive to the join query, and the contribution of the terminating attribute to a result is weighted by a number of possible pathways identified between an initial set of attributes and the terminating attribute.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an embodiment of a database processing system.

FIG. 2 illustrates an embodiment of a join data graph.

FIG. 3 illustrates an embodiment of an approximate processing of a join query between three different relational tables.

FIG. 4 illustrates an embodiment of a step in an approximate processing of a join query between three different relational tables.

FIG. 5 illustrates an embodiment of another step in an approximate processing of a join query between three different relational tables.

FIG. 6 illustrates an embodiment of a further step in an approximate processing of a join query between three different relational tables.

FIG. 7 illustrates an embodiment of a walk-optimization problem.

FIG. 8 illustrates an embodiment of a join query graph.

FIG. 9 illustrates an embodiment of a directed join query graph.

FIG. 10 illustrates an embodiment of a walk plan generation for a cyclic query graph.

FIG. 11 illustrates an embodiment of a decomposition of a join query graph.

FIG. 12 illustrates a flowchart of steps in an embodiment of a method for approximate processing of complex join queries.

FIG. 13 illustrates a flowchart of steps in another embodiment of a method for approximate processing of complex join queries.

### DETAILED DESCRIPTION

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

Disclosed embodiments provide for systems, methods, and apparatus that are capable of quickly performing join operations and providing confidence levels relating to the requested data. Disclosed embodiments are further capable of operating within conventional, ordered databases. In particular, disclosed embodiments are capable of functioning with non-randomized datasets.

In at least one embodiment, a user provides a query to a database. The database begins processing the query. During the processing, disclosed embodiments cause a user interface to display an estimated result to the query. Additionally, in at least one embodiment, disclosed embodiments cause a user interface to also display a confidence factor. The confidence factor indicates a confidence in the displayed estimated result. As the query is allowed to process over time, the estimated result is updated and the confidence factor increases.

Various disclosed embodiments provide significant increases in processing speed necessary to arrive at an acceptable result to a query. For example, in some embodiments magnitudes of performance is gained. Further, embodiments provide results that do not require an entire dataset to be processed. For example, some conventional systems must complete the entire query before a result is provided. In contrast, disclosed embodiments provide a result nearly instantly. Accordingly, the query can be cancelled at any time and a result is still provided.

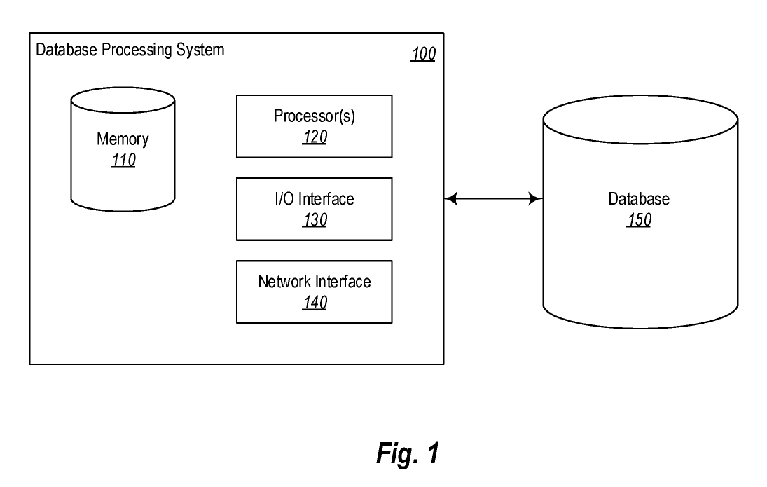

Turning now to the figures, FIG. 1 illustrates an embodiment of a database processing system 100. The database processing system 100 comprises memory 110, processor(s) 120, an I/O interface 130, and a network interface 140. The database processing system 100 is also in communication with a database 150. In various embodiments, different aspects of the database processing system 100 are otherwise arranged, described, combined, or separated. For example, the database processing system 100 may be executed within a distributed system that comprises multiple processors 120 distributed between multiple computer systems and in communication through the network interface 140.

In at least one embodiment, the memory 110 comprises local memory such as RAM, a solid-state drive (SSD), or a hard drive. The memory 110 can be used to hold data from the database 150 while the processor(s) 120 perform various functions that will be described herein. Additionally, the I/O interface 130 may be in communication with various input and output devices such as a keyboard, a mouse, a touch interface, a display, speakers, and other similar devices.

The database 150 comprises various conventional and/or non-conventional datasets. For example the data within the database 150 may be ordered or random. Additionally, the data may comprise relational data upon which join queries are executable. The various components of the database processing system 100 and database 150 will be described more fully with reference to embodiments disclosed herein.

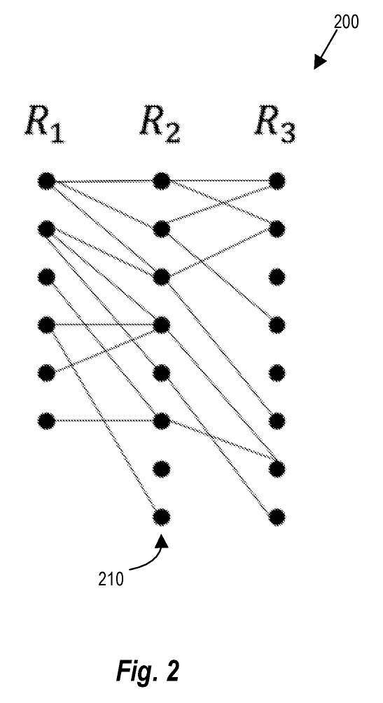

For example, FIG. 2 illustrates an embodiment of a join data graph 200. The depicted join data graph 200 depicts a natural join between three tables: R1(A,B) join, R2(B,C), and join R3(C,D). R1(A,B) means that R1 has two attributes A and B. R2(B,C) means that R2 has two attributes B and C. R3(C,D) means that R3 has two attributes C and D. The natural join returns all combinations of tuples from the three tables that have matching values on their common attributes. In the depicted embodiment, the database processing system 100 assumes that R2 has an index on attribute B, R3 has an index on attribute C, and the aggregation function is SUM(D). The depicted graph is provided only for the sake of example and explanation. In various embodiments, a join data graph 200 is not actually constructed when executing a query against a database as disclosed herein.

The join relationships are modeled among the tuples as a graph. Each tuple is modeled as a vertex and there is an edge between two tuples if they can join. For the example natural join, it means that the two tuples have the same value on their common attribute. In the depicted join data graph 200, each join result becomes a path from some vertex in R1 to some vertex in R3, and sampling from the join boils down to sampling a path.

In at least one embodiment, a path is randomly sampled by first picking a vertex in R1 uniformly at random, and then “randomly walking” towards R3. As used herein, a “random walk” is a description of disclosed embodiments for approximate processing of complex join queries. In every step of the random walk, the database processing system 100 determines the number of edges the current vertex has to the next table. In at least one embodiment, the number of edges is identified using an index associated with the column of interest in the next table. The database processing system 100 then uniformly at random picks a neighboring vertex to which the current vertex connects.

In at least one embodiment, this process does not yield a uniform sample. For example, path gamma is sampled with probability

p(gamma)=1/|R1|*1/d2(t1)*1/d3(t2)

where di+1(ti) is the number of tuples in Ri+1 that join with ti. The expression on gamma to be aggregated is v(gamma). An unbiased estimate is then returned by v(gamma)/p(gamma).

The database processing system 100 then independently performs multiple random walks, and takes the average of the estimators v(gamma_i)/p(gamma_i). One will understand that this is merely one example of many possible aggregator functions that can be used. As such, this function is provided for the sake of example and explanation.

In at least one embodiment, a random walk is also capable of failing. For example, a random walk fails if it reaches vertex 210 because it is not able to find an edge that continues to a vertex in R3. In this case, the database processing system 100 returns 0 as the estimate, which will be averaged together with all the successful random walks.

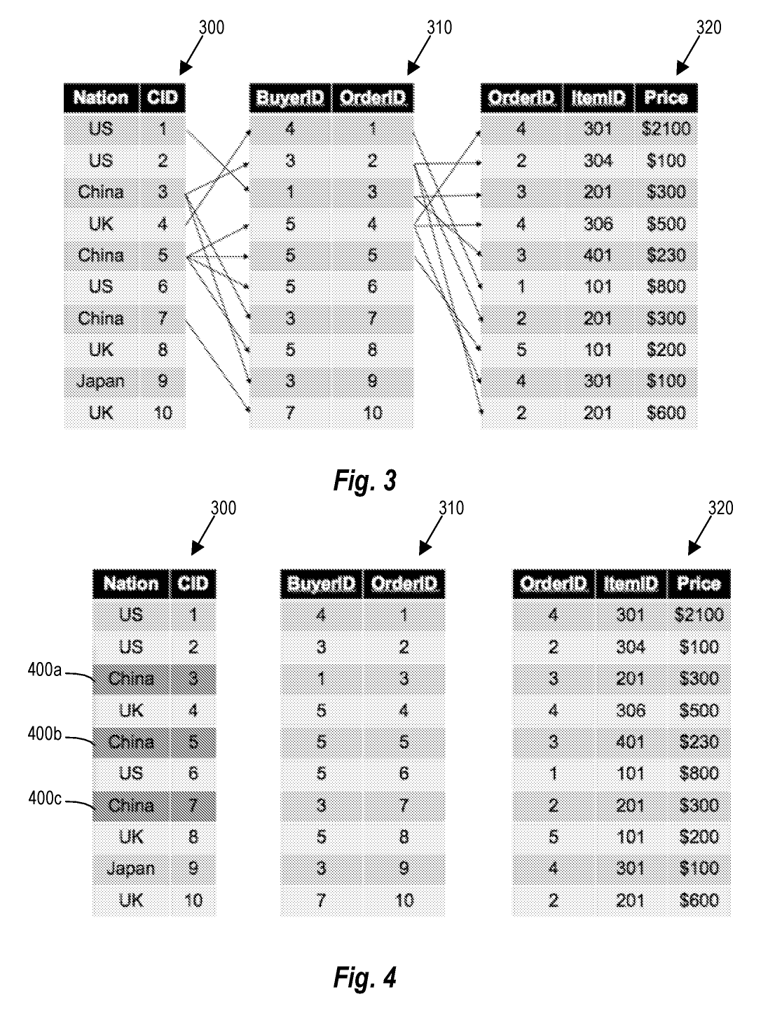

Turning now to an example of a join query. FIG. 3 illustrates an embodiment of an approximate processing of a join query between three different relational tables 300, 310, 320. In the depicted example, a database processing system 100 receives a join query directed towards a set of tables. The join query requests the total value of sales to China. Each table within the set of tables is associated with an index for at least one column of attributes. In the depicted example, table 300 has an index for the “Nation” column, table 310 has an index for the “BuyerID” column, and table 320 has an index for the “OrderID” column.

FIG. 3 depicts the various vertexes and edges between the responsive attributes within the three different relational tables 300, 310, 320. As used herein, an attribute is responsive if it is associated with a vertex. FIG. 4 depicts the results on an initial join query (also referred to herein as a “join operation”) applied to the index of table 300. In particular, three different entries 400(a-c) for “China” are shown as highlighted. One will understand that the highlighting is only shown for the sake of clarity and that in practice the entries may not be highlighted or otherwise displayed.

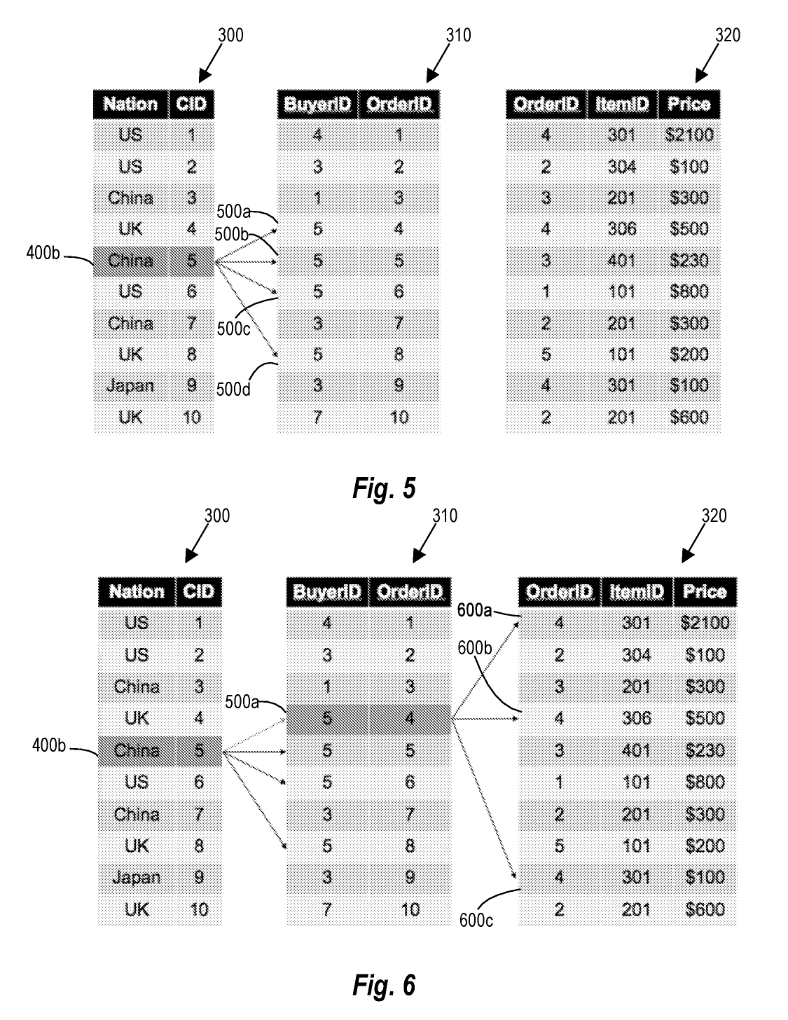

Once the responsive entries 400(a-c) are identified, the database processing system 100 randomly selects an attribute from the index associated with table 300. As depicted in FIG. 4, in at least one embodiment, randomly selecting the attribute comprises randomly selecting the attribute from a subset of attributes within the index associated with the table. In particular, the selected responsive attribute is selected based upon a query applied to the table 300. As such, in this case, only the subset of attributes associated with “China” are selected. For example, FIG. 5 depicts that attribute 400b was randomly selected.

Once a responsive attribute 400b is randomly selected the database processing system 100 identifies a number of possible pathways (also referred to herein as “edges”) from the selected attribute 400b to a set of attributes 500(a-d) in another table 310 within the set of tables. In the depicted example, the database processing system 100 identifies four different pathways, or edges. Each pathway is representative of a possible join between the selected attribute 400b and the attributes 500(a-d) within the set of attributes.

The database processing system 100 then randomly selects one of the attributes 500(a-d) from the second set of attributes. For example, as depicted in FIG. 6 the database processing system 100 randomly selects responsive attribute 500a. Once a responsive attribute 500a is randomly selected the database processing system 100 identifies a number of possible pathways from the selected attribute 500a to a set of attributes 600(a-c) in the next table 320 within the set of tables. In the depicted example, the database processing system 100 identifies three different pathways. Each pathway is representative of a possible join between the selected attribute 500a and the attributes 600(a-c) within the third set of attributes.

The above process of identifying responsive attributes and randomly selecting one continues until a terminating attribute is identified. As used herein, a terminating attribute is a responsive attribute within the final table in the set of tables. In at least one embodiment, the terminating attribute is directly responsive to the original join query. For instance, continuing the above example, the database processing system 100 randomly selects attribute 600b from the set of attributes 600(a-c) in the third table 320.

The database processing system 100 also identifies that attribute 600b is a terminating attribute. In this embodiment, attribute 600b is a terminating attribute because the pathway successfully completes at attribute 600b. Further, attribute 600b is also a terminating attribute because it is associated with $500, which is directly responsive to the original join query of how much is the total value of sales to china.

Once the database processing system 100 identifies a terminating attribute, the database processing system 100 calculates a result to the original join query. In particular, the contribution of the terminating attribute to the result is weighted by a number of possible pathways identified between an initial set of attributes and the terminating attribute. As used herein, the initial set of attributes is the responsive attributes 400(a-c) in the first table 300 that led to the terminating attribute 600b in the final table 320. In at least one embodiment, the number of possible pathways comprises a multiplication of one divided by of the number of pathways at each table. For example, the first table 300 comprises three initial pathways (e.g., the edges to attributes 400(a-c)). The second table 310 comprises four pathways (e.g., the edges to attributes 500(a-d)). The third table 320 comprises three pathways (e.g., the edges to attributes 600(a-c)). As such, the resulting weighting equation comprises:

$$\frac{\$500}{\frac{1}{3} \times \frac{1}{4} \times \frac{1}{3}} = \$18 , 000$$

The database processing system 100 then causes an initial result of $18,000 to be displayed to a user through an interface. In at least one embodiment, the database processing system 100 also displays a confidence factor that indicates the confidence associated with the initial result. In at least one embodiment, the confidence factor depends at least in part on a number of terminating attributes that are accounted for in the result. The confidence factor is calculated using methods known to those skilled in the art.

The database processing system 100 continues to iterate through the method described above. For example, using the methods described herein, the database processing system 100 repeatedly, randomly selects individual attributes from the index associated with table 300. The database processing system 100 repeatedly identifies numbers of possible pathways from each individual selected attribute to a set of attributes in the next table, until a terminating attribute is reached or until the random walk fails.

As such, database processing system 100 randomly selects an attribute from each set of responsive attributes. If a random walk is successful, the database processing system 100 then identifies an individual terminating attribute within the set of tables. The contribution of each individual terminating attribute to the result is weighted by the number of possible pathways identified between each selected individual attribute and the individual terminating attribute for each iteration.

For example, in at least one embodiment, the database processing system 100 iterates the process by randomly selecting an attribute from the first set of attributes 400(a-c) associated with the first table 300. As different attributes are randomly selected along the possible pathways until terminating attributes are identified, different results are calculated. For instance, different random selections of attributes may be associated with different numbers of possible pathways. Further, different terminating attributes may also be associated with different prices.

In at least one embodiment, as additional results are calculated, each result is averaged into the previously calculated results. Accordingly, each time the database processing system 100 iterates through the database 150, the confidence factor can increase and the results can become more accurate. As such, the database processing system 100 displays on a user interface an indication of the result that reflects a most recent version of the result. Each time the database processing system 100 iterates through the method, the result can change. In at least one embodiment, with each iteration the database processing system 100 also displays on the user interface an updated indication of the confidence factor.

In at least one embodiment, if the database processing system 100 is allowed to run long enough, eventually all of the attributes will be accounted for and the exact result will be reached. In at least one embodiment, in order for the exact result to be reached, the database processing system 100 prevents the same attributes from being randomly sampled more than once. For example, the database processing system 100 tracks individual attributes that have been previously been randomly selected. The database processing system 100 then prevents previously selected individual attributes from being selected again. For example, the database processing system 100 may prevent attributes from one of the tables, a subset of the tables, or all of the tables from being selected more than once.

However, one will understand that in various circumstances it may not be necessary to identify an exact answer. Instead, the database processing system 100 can be allowed to run for a shorter period of time until a certain confidence factor is reached. The associated result may be close enough to the actual result that the additional computing time is not worth it to the user.

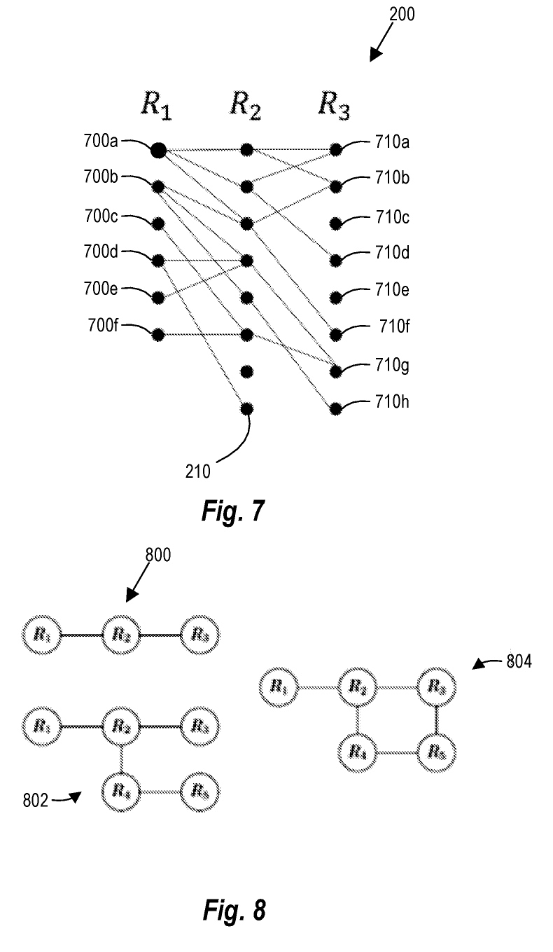

In at least one embodiment, the database processing system 100 also identifies an ideal ordering for performing the method described herein on tables within a set of tables. For example, FIG. 7 illustrates an embodiment of a walk-optimization problem using a join data graph 200 of FIG. 2. As explained above, a walk fails if it does not reach a terminating attribute. For example, a random walk that includes vertex 210 would fail because vertex 210 does not connect with table R3.

In at least one embodiment, each failed random walk represents wasted resources for the database processing system 100. As such, it is desirable to minimize the number of failed random walks and to maximize the number of successful walks. In at least one embodiment, the database processing system 100 performs walk optimization to identify an ideal ordering of tables. For example, depending upon the join query and the tables involved, in at least one embodiment, various different orderings of tables may be used to generate a result. In such a case, the database processing system 100 performs a threshold number of test queries using various different table orderings. For instance, the database processing system 100 may apply the query to the tables 200 in the follow orderings R1→R2→R3 or R2→R3→R1 or R3→R2→R1 or R2→R1→R3 or R1→R3→R2 or R3→R1→R2. In the present example, there are six unique possible orderings of the tables. However, in various alternative embodiments there may be a different number of possible orderings. Further, in at least one embodiment, the database processing system 100 may randomly select only a few of the possible orderings to test.

As a non-limiting example of a walk optimization, the database processing system 100 may attempt 100 random walks through various ordering of the tables R1, R2, R3. As depicted in FIG. 7, some orderings may provide a higher proportion of successful walks compared to failed walks. For example, database processing system 100 may attempt a threshold number of random walk attempts using a table ordering of R1→R2→R3. As depicted, a random walks beginning from vertexes 700(b-f) will result in a failed random walk because they do not have pathways to vertexes in table R3. As such, the database processing system 100 will identify that randomly selected responsive attributes have a low likelihood of successful random walks.

The database processing system 100 may also attempt a threshold number of random walks using a table ordering of R3→R2→R1. In FIG. 7, this ordering is reflected by randomly walking from the right side of the join data graph 200 to the left side. In particular, ordering all possible random walks relating to vertexes 710(a-h) results in a successful walk. As such, the join data graph 200 will determine that the ordering R3→R2→R1 has a high likelihood of success. The join data graph 200 may perform a threshold number of random walks on various other possible orderings. In at least one embodiment, however, the join data graph 200 determines that the R3→R2→R1 ordering is the ideal ordering because it is associated with the highest proportion of successful random walks in comparison to the total number of random walks attempted on that ordering.

Accordingly, in at least one embodiment, the database processing system 100 initially identifies an ideal ordering of the tables by performing a threshold number of random walks on various different orderings of the tables. A threshold number of random walks may comprise a set number of walks per ordering, such as one hundred attempted random walks. Once an ideal ordering of tables is identified, the database processing system 100 performs the approximate processing of complex join queries using the ideal ordering. While the example provided in FIG. 7 depicts only three different tables, in alternative embodiments, any number of tables with any number of entries may be utilized.

In various embodiments, although the algorithm above is described on a simple three-table chain join, it can be extended to arbitrary joins easily. For example, FIG. 8 shows some possible join query graphs 800, 802, 804. In at least one embodiment, when the join query graph is acyclic (e.g., join query graph 802), the methods and systems disclosed herein are extended in a straightforward manner. First database processing system 100 determines a walk order such that each table in the walk order must be adjacent (in the query graph) to another one earlier in the order. For example, for the query graph in join query graph 802, R1→R2→R3→R4→R5 and R2→R3→R4→R5→R1 are both valid walk orders, but R1→R3→R4→R5→R2 is not.

Next, the database processing system 100 performs the random walks as described before, following the given order. In at least one embodiment, the only difference is that a random walk now consists of both “walks” and “jumps”. For example, using the order R1→R2→R3→R4→R5 on join query graph 802, after the database processing system 100 has reached a tuple in R3, the next table to walk to is R4, which is connected to the part already walked via R2. As such, the database processing system 100 jumps back to the tuple that was picked in R2, and continues the random walk from there.

Finally, the database processing system 100 utilizes the following equation:

$$p ( γ ) = \frac{1}{\vert {R}_{λ ( 1 )} \vert} {\prod }_{i = 2}^{k} \frac{1}{{d}_{λ ( i )} ( {t}_{η ( i )} )}$$

In this equation, d_{λ}(t) is the number of tuples in R_{λ} that can join with t, where t is a tuple from another table that has a join condition with R_{λ}. Suppose the walk order is R_{λ}(1), R_{λ}(2), . . . , R_{λ}(k), and let R_{η}(i) be the table adjacent to R_{λ}(i) in the query graph but appearing earlier in the order. Then for the path γ=(t_{λ}(1), . . . , t_{λ}(k)), where t_{λ}(i) belongs to R_{λ}(i), the sampling probability of the path is provided by the above equation.

The methods and systems for acyclic queries can also be extended to handle query graph with cycles. For example, join query graph 804 depicts a query graph with a circle. In such a case, the database processing system 100 identifies any spanning tree of the join query graph 804. The database processing system 100 then performs the random walks on this spanning tree in the same way it was performed on join query graph 804 802 (e.g., R1→R2→R3→R4→R5).

After the database processing system 100 has sampled a path on the spanning tree, the database processing system 100 puts back the non-spanning tree edges, e.g., (R3→R5), and verifies that it should satisfy the join conditions on these edges. For example, after the database processing system 100 has sampled a path gamma=(t1; t2; t3; t4; t5) on join query graph 802 (assuming the walk order R1→R2→R3→R4→R5), then the database processing system 100 needs to verify that it should satisfy the non-spanning tree edge (R3→R5), i.e., t3 should join with t5. If they do not join, the database processing system 100 considers it as a failed random walk and returns an estimator with value 0.

In at least one embodiment, the database processing system 100 easily deals with arbitrary selection predicates in the query. For example, in the random walk process, whenever the database processing system 100 reaches a tuple t for which there is a selection predicate, the database processing system 100 checks if it satisfies the predicate, and fails the random walk immediately if not. If the starting table of the random walk has an index on the attribute with a selection predicate, and the predicate is an equality or range condition, then the database processing system 100 directly samples a tuple that satisfies the condition from the index. Correspondingly, the database processing system 100 replaces R_{λ}(1) in the above equation by the number of tuples in R_{λ}(1) that satisfy the condition, which can also be computed from the index. This removes the impact of the predicate on the performance of the random walk. In at least one embodiment, it is preferable to start from such a table. If there is a GROUP BY clause in the query, the database processing system 100 remains the same, except that each random walk path will end up in one of the groups and an estimator (and its confidence interval) is maintained for each group separately.

In at least one embodiment, for the last table in the random walk, instead of sampling one tuple from the table, the database processing system 100 visits all of the tuples (which are stored together in the index). This way, the database processing system 100 is essentially getting multiple paths at the cost of one walk. However, these paths are not independently chosen, so database processing system 100 considers them as one “combined” path.

In at least one embodiment, the database processing system 100 provides optimizations for dealing with highly selective predicates. Suppose the database processing system 100 walks from a tuple t to a table R with a selection predicate, and the selectivity is rho (i.e., a fraction of rho of the tuples on R satisfy the predicate). If rho is small, this may fail many of the random walks. More precisely, suppose table R is the i-th table in the walk order, then the database processing system 100 would expect to spend i/rho steps to successfully “pass” R. In this case, the database processing system 100 first finds d(t), the number of neighbors oft in R. If d(t)<i/rho, the database processing system 100 checks each neighbor of t, and collects those that satisfy the predicate. Then the database processing system 100 chooses one randomly to walk to only from these tuples. Note that the degree oft used in the above equations should be modified accordingly.

As explained above with reference to FIG. 7, different orders to perform the random walk may lead to very different performances. In at least one embodiment, the constraint for a valid walk order is that for each table Rᵢ (except the first one in the order), there must exist a table Rⱼ earlier in the order such that there is a join condition between Rᵢ and Rⱼ. In addition, Rᵢ should have an index on the attribute that appears in the join condition. Note that the join condition does not have to be equality. It can be for instance an inequality or even a range condition, such as Rⱼ.A<Rᵢ.B<Rⱼ.A+100, as long as Rᵢ has an index on B that supports range queries (e.g., a B-tree).

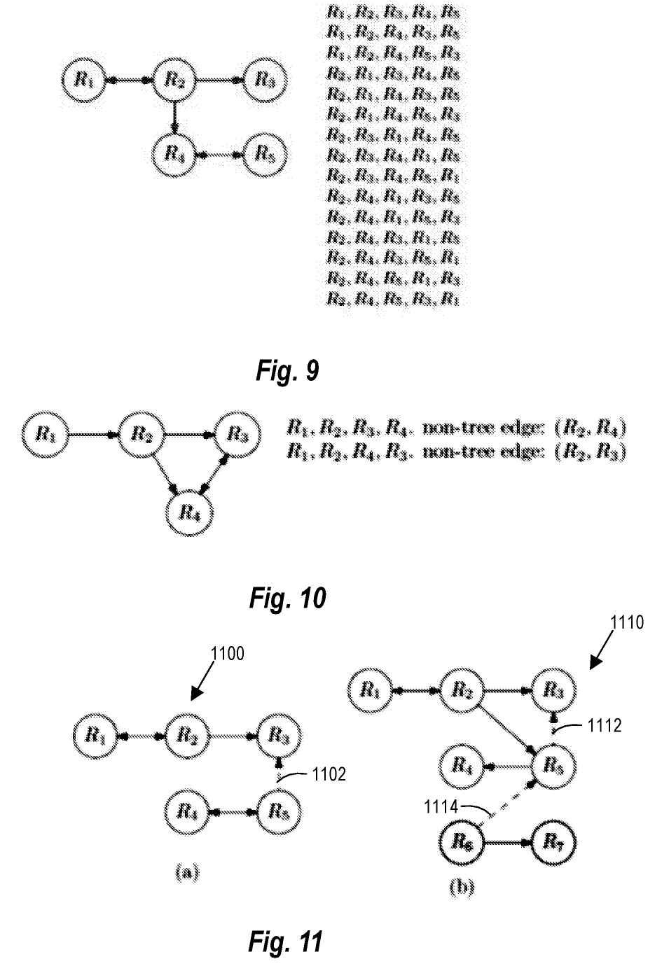

Under the constraint above, there may or may not be a valid walk order. To generate all possible walk orders (also referred to herein as orderings), the database processing system 100 first adds directions to each edge in the join query graph. Specifically, for an edge between Rᵢ and Rⱼ, if Rᵢ has an index on its attribute in the join condition, a directed edge exists from Rⱼ to Rᵢ; similarly if Rⱼ has an index on its attribute in the join condition, a directed edge exists from Rᵢ to Rⱼ. For example, after adding directions, the join query graph 802 might look like the one in FIG. 9, and all possible walk plans are listed on the side. These plans can be enumerated by a simple backtracking algorithm. The database processing system 100 can similarly generate all possible walk plans for cyclic queries, just that some edges will not be walked, and they will have to be checked after the random walk. The edges are referred to as non-tree edges, since the part of the graph that is covered by the random walk form a tree. An example is given in FIG. 10.

The situation gets more complex when there is no valid walk order, like for the two join query graphs 1100, 1110 in FIG. 11 (dashed edges 1102, 1112, 1114 are also part of the query graphs 11). First, the sufficient and necessary condition for a query graph to admit at least one valid walk order is that it has a directed spanning tree. When there are not enough indexes, this condition may not hold, in which case the database processing system 100 will have to decompose the query graph into multiple components such that each component has a directed spanning tree. FIG. 11 shows how the two query graphs can be decomposed, where each component is connected by solid edges.

After the database processing system 100 has found directed spanning tree decomposition, the database processing system 100 generates walk orders for each component, as described above. A walk plan now is any combination of the walk orders, one for each component. The database processing system 100 will then run a conventional ripple join on the component level and wander join within each component. More precisely, the database processing system 100 performs random walks for the components in a round-robin fashion, and keeps all successful paths in memory. For each newly sampled path, the database processing system 100 joins it with all the paths from other tables. For example, the database processing system 100 checks (R3→R5) in join query graph 1100 and (R5→R6) in join query graphs 1110. Note that (R3→R5) in join query graph 1100 is checked by using random walks as disclosed herein for the component {R1→R2→R3→R4→R5}.

It remains to describe how to find a directed spanning tree decomposition. For a given query graph G=(V,E), the database processing system 100 proceeds in three steps. In step one, for each vertex v, the database processing system 100 finds the set of all vertices reachable from v, denoted as T(v). Then, the database processing system 100 removes T(v) if it is dominated (i.e., completely contained) in another T(v′). For example, for join query graph 1110, only T(R1)={R1→R2→R3→R4→R5} and T(R6)={R3→R4→R5→R6→R7} remain, since other T(v)'s are dominated by either T(R1) or T(R6).

In step 2, database processing system 100 finds the smallest subset of vertices C such that the T(v)'s for v in C cover all vertices, by exhaustively checking all subsets C of U. This gives the smallest cover, not a decomposition, since some vertices may be covered by more than one T(v). For example, T(R1) and T(R6) are the optimal cover for join query graph 1110, and they both cover R3, R4, R5.

In step 3, the database processing system 100 converts the cover into a decomposition. Denote the set of multiply covered vertices as M, and let G_{M}=(M, E_V) be the induced subgraph of G on M. The database processing system 100 will assign each u in M to one of its covering T(v)'s. The database processing system 100 first finds the strongly-connected components of G_{M}, contract each to a “super vertex” (containing all vertices in this strongly connected component). Then the database processing system 100 does a topological sort of the super vertices; inside each super vertex, the vertices are ordered arbitrarily. Finally, the database processing system 100 assigns each u in M to one of its covering T(v)'s by this order: if u has one or more predecessors in G_{M} that have already been assigned, the database processing systems 100 assigns u to the same T(v) as one of its predecessors; otherwise u can be assigned to any of its covering T(v)'s. For join query graph 1110 the topological order for M is R5, R3, R4 or R5, R4, R3, and in this example, the database processing system 100 has assigned all of them to T(R1).

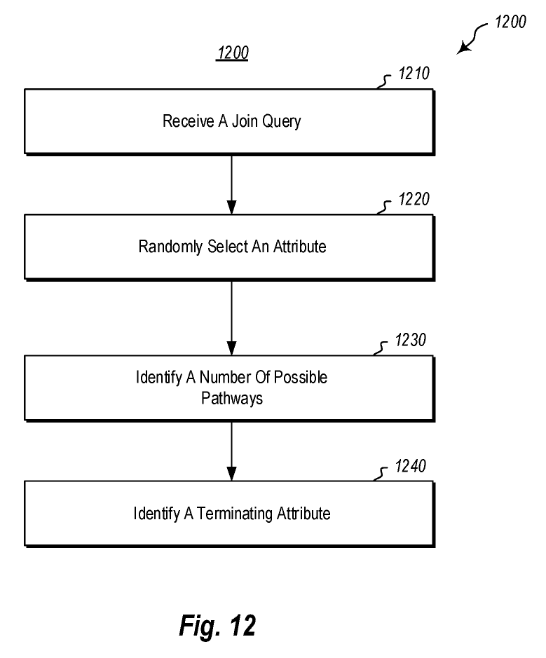

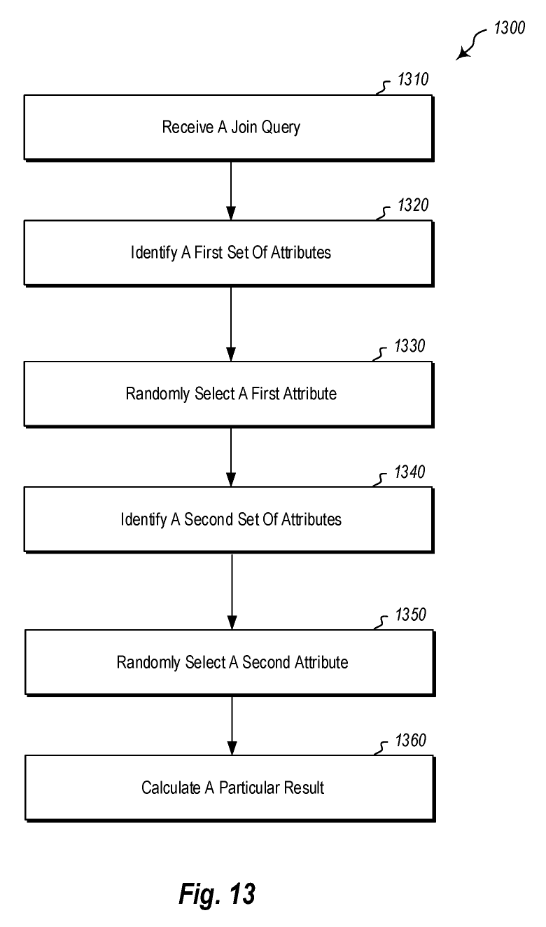

One will appreciate that embodiments disclosed herein can also be described in terms of flowcharts comprising one or more acts for accomplishing a particular result. For example, FIGS. 12 and 13 and the corresponding text describe acts in various systems for approximate processing of complex join queries. The acts of FIGS. 12 and 13 are described below.

For example, FIG. 12 illustrates a flowchart 1200 for an embodiment of a method for approximate processing of complex join queries. The illustrated acts comprise an act 1210 of receiving a joint query. Act 1210 includes receiving a join query directed towards a set of tables, wherein each table within the set of tables is associated with an index for at least one column of attributes within the table. For example, as depicted and described with respect to FIGS. 1 and 3, an I/O interface 130 in a database processing system 100 can receive a join query from a user. The joint query can be applied against a set of tables 300, 310, 320 that are associated with the various indexes.

FIG. 12 also illustrates an act 1220 of randomly selecting an attribute. Act 1220 includes randomly selecting an attribute from an index associated with a table from the set of tables, wherein the selected attribute is selected based upon a query applied to the table. For example, as depicted and described with respect to FIG. 4, a database processing system 100 randomly selects an attribute 400b from an index associated with table 300.

Additionally, FIG. 12 illustrates an act 1230 of identifying a number of possible pathways. Act 1230 includes identifying a number of possible pathways from the selected attribute to a set of attributes in another table within the set of tables. Each pathway is representative of a possible join between the selected attribute and the attributes within the set of attributes. For example, as depicted and described with respect to FIGS. 3 and 6, a database processing system 100 identifies that there are three possible pathways associated with table 300, four possible pathways associated with table 310, and three possible pathways associated with table 320.

Further, FIG. 12 illustrates an act 1240 of identifying a terminating attribute. Act 1240 includes identifying a terminating attribute within the set of attributes, wherein the terminating attribute is responsive to the join query, and a contribution of the terminating attribute to a result is weighted by a number of possible pathways identified between an initial set of attributes and the terminating attribute. For example, as depicted and described with respect to FIG. 6, a database processing system 100 identifies attribute 600b as a terminating attribute. The value, $500, associated with attribute 600b is weighted by the above identified number of possible pathways between the initial set of attributes 400(a-c) and the terminating attribute 600b.

For example, FIG. 13 depicts a flowchart 1300 for an embodiment of a method for processing of complex drawing queries. The illustrated acts comprise act 1310 of receiving a join query directed towards generating a particular result based at least in part on data contained within a first table and a second table. For example, as depicted and described with respect to FIGS. 1 and 3, an I/O interface 130 in a database processing system 100 can receive a join query from a user. The joint query can be applied against a set of tables 300, 310, 320 that are associated with the various indexes.

FIG. 13 also illustrates an act 1320 of identifying a first set of attributes. Act 1320 includes identifying, from a first index associated with a first column of the first table, a set of first attributes that conform with the joint query, wherein the first column comprises first attributes. For example, as depicted and described with respect to FIGS. 3 and 4, a database processing system 100 identifies a set of first attributes 400(a-c) that are associated with a joint query directed towards identifying the total value of purchases from China.

Additionally, FIG. 13 illustrates an act 1330 of randomly selecting a first attribute. Act 1330 includes randomly selecting a particular first attribute from the set of first attributes. For example, as depicted and described with respect to FIG. 5, a database processing system 100 randomly selects attribute 400b.

FIG. 13 further illustrates an act 1340 of identifying a second set of attributes. Act 1340 includes identifying, from a second index associated with a second column of the second table, a set of second attributes to which the particular first attribute maps, wherein the second column comprises second attributes. For example, as depicted and described with respect to FIGS. 5 and 6, a database processing system 100 identifies attributes 500(a-d) from a second column of table 310. As used herein, the “second column” does not describe the sequential ordering of the column within table 310, instead the “second column” is used merely to differentiate from a first column in table 300.

In addition, FIG. 13 illustrates an act 1350 of randomly selecting a second attribute. Act 1350 includes randomly selecting a particular second attribute from the set of second attributes. For example, as depicted and described with respect to FIGS. 5 and 6, a database processing system 100 randomly selects attribute 500a from a second set of attributes 500(a-d).

Further, FIG. 13 illustrates an act 1360 of calculating a particular result. Act 1360 includes calculating the particular result to the join query based, at least in part, upon the particular second attribute. A contribution of the particular second attribute to the particular result is weighted by a probability factor determined at least in part by a number of first attributes in the first set of attributes in a number of second attributes in the second set of attributes. For example, as depicted and described with respect to FIG. 6, a database processing system 100 identifies an attribute 600b that is associated with a value of $500. The database processing system 100 calculates the contribution of the $500 value to the particular result by weighting it with a probability factor that is determined by the number of attributes (also referred to herein as pathways or edges) identified in each table along the random walk that ended with attribute 600b. In particular, the contribution is weighted by the three attributes 400(a-c) found in table 300, the four attributes 500(a-d) found in table 310 and the three attributes 600(a-c) found in table 320.

Accordingly, embodiments disclosed herein provide systems and methods for quickly returning results to complex join queries that do not necessarily account for every possible attribute within the dataset. As such, the results can be provided much more quickly and are continually updated such that even an interrupted query still returns useful information. Further, results can be displayed to a user along with a confidence factor that indicates a confidence in the approximate result.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available. Examples of software user interfaces include graphical user interfaces, text command line based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for approximate processing of complex join queries, comprising:
one or more processors; and
one or more computer-readable media having stored thereon executable instructions that when executed by the one or more processors configure the computer system to perform at least the following:
receive a join query directed towards a set of tables, wherein each table within the set of tables is associated with an index for at least one column of attributes within the table;
randomly select an attribute from an index associated with a table from the set of tables, wherein the selected attribute is selected based upon a query applied to the table;
identify a number of possible pathways from the selected attribute to a set of attributes in another table within the set of tables, wherein each pathway is representative of a possible join between the selected attribute and the attributes within the set of attributes; and
identify a terminating attribute within the set of tables, wherein:
the terminating attribute is responsive to the join query,
and
a contribution of the terminating attribute to a result is weighted by a number of possible pathways identified between an initial set of attributes and the terminating attribute.

2. The computer system as recited in claim 1, wherein randomly selecting the attribute comprises randomly selecting the attribute from a subset of attributes within the index associated with the table from the set of tables.

3. The computer system as recited in claim 1, wherein the set of tables comprises a series of tables that are sequentially ordered based upon an ideal ordering of the tables within the set of tables.

4. The computer system as recited in claim 3, wherein the executable instructions include instructions that are executable to configure the computer system to:
perform a threshold number of join operations on the set of tables for various different orderings of tables within the set of tables;
for each specific ordering of tables, track a number of successful walks, wherein a successful walk is completed when a pathway is identified between a first table and a last table; and
identify from within the various different orderings an ideal ordering that resulted in a highest proportion of successful walks.

5. The computer system as recited in claim 1, wherein the executable instructions include instructions that are executable to configure the computer system to calculate a confidence factor associated with the result, wherein the confidence factor depends at least in part on a number of terminating attributes that are accounted for in the result.

6. The computer system as recited in claim 5, wherein the executable instructions include instructions that are executable to:
display on a user interface an indication of the result that reflects a most recent version of the result; and
display on the user interface an indication of the confidence factor.

7. The computer system as recited in claim 1, wherein the executable instructions include instructions that are executable to:
repeatedly, randomly select individual attributes from the index associated with the table from the set of tables;
repeatedly identify numbers of possible pathways from each individual selected attribute to a set of attributes in the other table within the set of tables; and
for at least a portion of each selected individual attribute, identify an individual terminating attribute within the set of tables, wherein the contribution of each individual terminating attribute to the result is weighted by a number of possible pathways identified between each selected individual attribute and the individual terminating attribute.

8. The computer system as recited in claim 7, wherein the executable instructions include instructions that are executable to:
track individual attributes that have been previously been randomly selected; and
prevent previously selected individual attributes from being selected again.

9. A computer system for approximate processing of complex join queries, comprising:
one or more processors; and
one or more computer-readable media having stored thereon executable instructions that when executed by the one or more processors configure the computer system to perform at least the following:
receive a join query directed towards generating a particular result based at least in part on data contained within a first table and a second table;
identify, from a first index associated with a first column of the first table, a set of first attributes that conform with the join query, wherein the first column comprises first attributes;
randomly selecting a particular first attribute from the set of first attributes;
identifying, from a second index associated with a second column of the second table, a set of second attributes to which the particular first attribute maps, wherein the second column comprises second attributes;
randomly selecting a particular second attribute from the set of second attributes;
calculating the particular result to the join query based, at least in part, upon the particular second attribute, wherein a contribution of the particular second attribute to the particular result is weighted by a probability factor determined at least in part by a number of first attributes in the first set of attributes and a number of second attributes in the second set of attributes.

10. The computer system as recited in claim 9, wherein the first table and the second table are sequentially ordered based upon an ideal ordering.

11. The computer system as recited in claim 10, wherein the executable instructions include instructions that are executable to configure the computer system to:
perform a threshold number of join operations on the first table and the second table for various different orderings of the first table and the second table;
for each specific ordering of the first table and the second table, track a number of successful walks, wherein a successful walk is completed when a pathway is identified between a first attribute and a second attribute; and
identify from within the various different orderings an ideal ordering that resulted in a highest proportion of successful walks.

12. The computer system as recited in claim 9, wherein the executable instructions include instructions that are executable to configure the computer system to calculate a confidence factor associated with the particular result, wherein the confidence factor depends at least in part on a number of particular second attributes that are accounted for in the particular result.

13. The computer system as recited in claim 9, wherein the executable instructions include instructions that are executable to:
repeatedly, randomly select first attributes from the set of first attributes;
repeatedly identifying, from the second index, sets of second attributes to which each selected first attribute maps;
randomly selecting particular second attributes from the sets of second attributes; and
wherein the contribution of each other particular second attribute to the particular result is weighted by the probability factor

14. The computer system as recited in claim 13, wherein the executable instructions include instructions that are executable to:
track second attributes that have previously been randomly selected; and
prevent previously selected second attributes from being selected again.

15. A method for approximate processing of complex join queries, comprising:
receiving a join query directed towards a set of tables, wherein each table within the set of tables is associated with an index for at least one column of attributes within the table;
performing a threshold number of join operations on the set of tables for various different orderings of tables within the set of tables;
for each specific ordering of tables, tracking a number of successful walks, wherein a successful walk is completed when a pathway is identified between a first table and a last table;
identifying from within the various different orderings an ideal ordering that resulted in a highest proportion of successful walks;
randomly selecting an attribute from an index associated with a first table from the set of tables, wherein the selected attribute is associated with the join query;
identifying a number of possible pathways from the selected attribute to a set of attributes in a second table within the set of tables, wherein:
each pathway is representative of a possible join between the selected attribute and the attributes within the set of attributes, and
the second table is ordered after the first table within the ideal ordering; and
identifying a terminating attribute within the second table, wherein:
the terminating attribute is responsive to the join query, and
the contribution of the terminating attribute to a result is weighted by a number of possible pathways identified between an initial set of attributes and the terminating attribute.

16. The method as recited in claim 15, wherein randomly selecting the attribute comprises randomly selecting the attribute from a subset of attributes within the index associated with the first table from the set of tables.

17. The method as recited in claim 15, further comprising calculating a confidence factor associated with the result, wherein the confidence factor depends at least in part on a number of terminating attributes that are accounted for in the result.

18. The method as recited in claim 17, further comprising:
displaying on a user interface an indication of the result that reflects a most recent version of the result; and
displaying on the user interface an indication of the confidence factor.

19. The method as recited in claim 15, further comprising:
repeatedly, randomly selecting individual attributes from the index associated with the first table from the set of tables;
repeatedly identifying numbers of possible pathways from each selected individual attribute to a set of attributes in the second table within the set of tables; and
for each selected individual attribute, identifying an individual terminating attribute within the second table, wherein the contribution of each individual terminating attribute to the result is weighted by the number of possible pathways identified between each selected individual attribute and each respective individual terminating attribute.

20. The method as recited in claim 19 further comprising:
tracking individual attributes that have been previously been randomly selected; and
preventing previously selected individual attributes from being selected again.
